(19) United States
(12) Patent Application Publication
(10) Pub. No.: US 2017/0199680 A1
(43) Pub. Date: Jul. 13, 2017

(54) SYSTEM AND METHOD OF WRITE AMPLIFICATION FACTOR MITIGATION AND FLASH LIFESPAN EXTENSION

(71) Applicant: Alibaba Group Holding Limited, Grand Cayman (KY)

(72) Inventor: Shu LI, San Jose, CA (US)

(21) Appl. No.: 14/994,530

(22) Filed: Jan. 13, 2016

(51) Int. Cl. G06F 3/06

(52) U.S. Cl. CPC G06F 3/0616; G06F 3/064; G06F 3/0688

(57) ABSTRACT

Embodiments of the present invention use a NAND block as the basic write operation unit and ensure that the write operation uses the same basic unit as the erase operation. In this way, the flash product maintains the same level of granularity for read and write operations. The mapping between logical block addressing (LBA) and physical block addressing (PBA) are at the page level. Wear leveling and garbage collection are simplified so the robustness and performance is enhanced. If the data is frequently written, there are no concerns regarding data retention. Embodiments of the present invention evenly distribute hot data using a global optimization perspective based on this observation. When dealing with hot data, the NAND flash's required data retention capability may be adjusted to increase P/E cycles.

### FIELD

Embodiments of the present invention generally relate to data storage systems. More specifically, embodiments of the present invention relate to systems and methods for reducing write amplification and extending the lifespan of flash-oriented file systems.

### BACKGROUND

In general, when any amount of data is written to a NAND flash block, the entire NAND flash block must be erased before new data can be rewritten. In some cases, a flash-based storage device (e.g., a solid state drive (SSD)) is used in a manner similar to traditional hard drives (HDDs), where files are partitioned or merged into logic blocks of 512 bytes, 4 k bytes, or more. SSD is typically characterized as high-performance storage device with high throughput, high Input/Output Operations per Second (IOPS), low latency, and low failure rate. An internal index associated with the logic block is referred to as the logical block address (LBA). The blocks are written to specific locations on the storage media, and the address is referred to as the physical block address (PBA). However, some conventional HDD operations, such as defragmentation operations, lead to a degradation of the performance and lifespan of the SSD.

In a typical case, an SSD receives a write command from a host and stores the associated data on one or more pages of one or more blocks. Initially, all blocks are available to write data and are referred to as free blocks. After data is written to a block, the block may be erased and added to a pool of free blocks. FIG. 1 illustrates an exemplary block writing and recycling technique. When a host sends a write request 101 to the SSD, the data is buffered and an available block 102 from a free block pool 103 is selected. Next, the data from the buffer is written to the selected free block. After the data has been written to the selected block, the block is added to a data block pool 104. Some files may be deleted and the corresponding pages are marked as invalid.

A block 105 with the fewest number of valid pages is selected for garbage collection, and the valid pages in this block are read and written to other blocks. After the block's data is copied and consolidated, the entire block is erased. After the block is erased, the block is considered to have finished one program/erase (P/E) cycle. However, the exemplary block writing and recycling technique depicted in FIG. 1 results in write amplification. Copying and rewriting the pages of the selected block takes place internally so these actions are not considered to be writing data from the host. Therefore, from the perspective of the NAND flash side, more data is written than is received from host. This phenomenon is known as write amplification.

FIG. 2 illustrates total P/E cycles for different generations of NAND flash in graph 200. With storage density increasing in subsequent generations, P/E cycles are reduced dramatically. Therefore, each P/E cycle of a NAND flash product becomes more and more important and directly determines the lifespan of the given device. With a fixed P/E cycle budget of 2× nm MLC, for example, each block can be erased 3000 times during the product lifespan. Assuming the average write amplification factor is 3, the maximum amount of data to be written into this NAND product is only 1000 times greater than the capacity of the device. As the total P/E cycles decrease for subsequent generations, the bits required for error correcting code increases. For example, the 3× nm MLC requires an 8-bit ECC and the 2× nm MLC requires a 15-bit ECC.

All SSDs have a write amplification value that represents the ratio of data written by the host to the SSD compared to the amount of data that is actually written to the SSD. Several factors may increase the write amplification value, including techniques that mitigate read and/or write disturbances and wear-leveling policies that move user data from aged segments into clean segments. Garbage collection policies may further increase write amplification. What is needed is an SSD device that efficiently handles sub-optimal usage (e.g., defragmentation operations), mitigates write amplification, and extends the lifespan of the device, all while keeping device-related costs low.

### SUMMARY

Methods and systems for managing data storage in flash memory devices are described herein. By using a distributed storage system to merge small files and write data block-by-block, the write amplification factor approaches an ideal value of 1.

According to one embodiment, a method of distributing data among a plurality of solid state drives to mitigate write amplification is described. The method includes receiving a write request comprising write data, determining a portion of the write data comprising hot data, dividing the hot data into a plurality of stripes, writing each of the plurality of stripes to a different solid state drive such that the hot data is relatively evenly distributed among the plurality of solid state drives.

According to another embodiment, an apparatus for distributing data among a plurality of solid state drives to mitigate write amplification is disclosed. The apparatus includes a load balancer configured to receive and direct data requests, wherein the data requests comprise write data, a distributed storage system configured to store data, and a plurality of solid state drives coupled to the distributed storage system. The distributed storage system directs the storage of data on the solid state drives such that frequently updated data is relatively evenly distributed amongst the solid state drives.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram illustrating an exemplary block writing and recycling technique for an exemplary SSD.

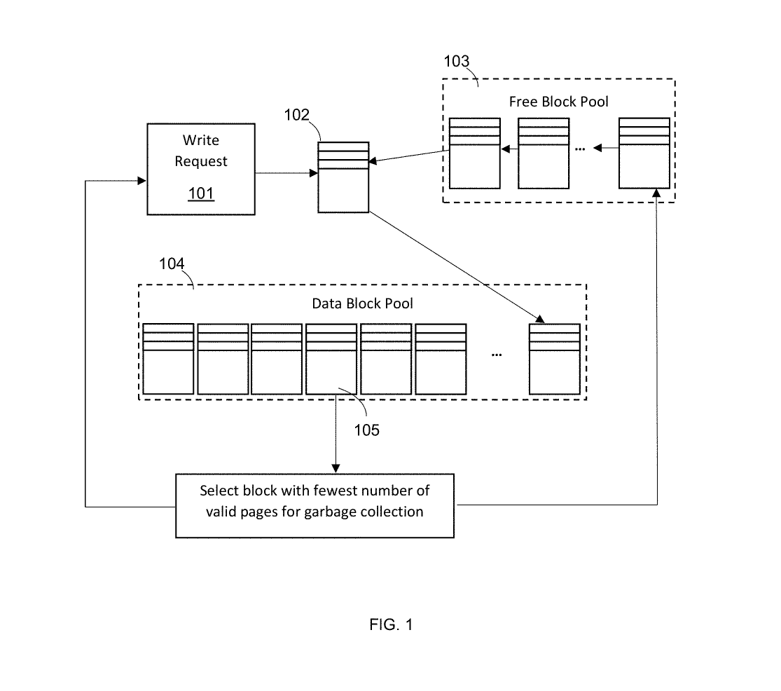

FIG. 2 is a graph illustrating the total P/E cycles for different generations of NAND flash.

FIG. 3 is a graph illustrating exemplary write amplification factors compared to an overprovisioning percentage for an exemplary SSD according to embodiments of the present invention.

FIG. 4 is a block diagram illustrating an exemplary cloud service system comprising a distributed storage system according to embodiments of the present invention.

FIG. 5 is a block diagram illustrating an exemplary distributed storage system configured as a file blender according to embodiments of the present invention.

FIG. 6 is a flow chart depicting an exemplary sequence of computer implemented steps for performing block-wise programming and erasing for hot data in a multi-SSD storage system according to embodiments of the present invention.

FIG. 7 is a graph illustrating exemplary retention times needed compared to a percentage of maximum cycles according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

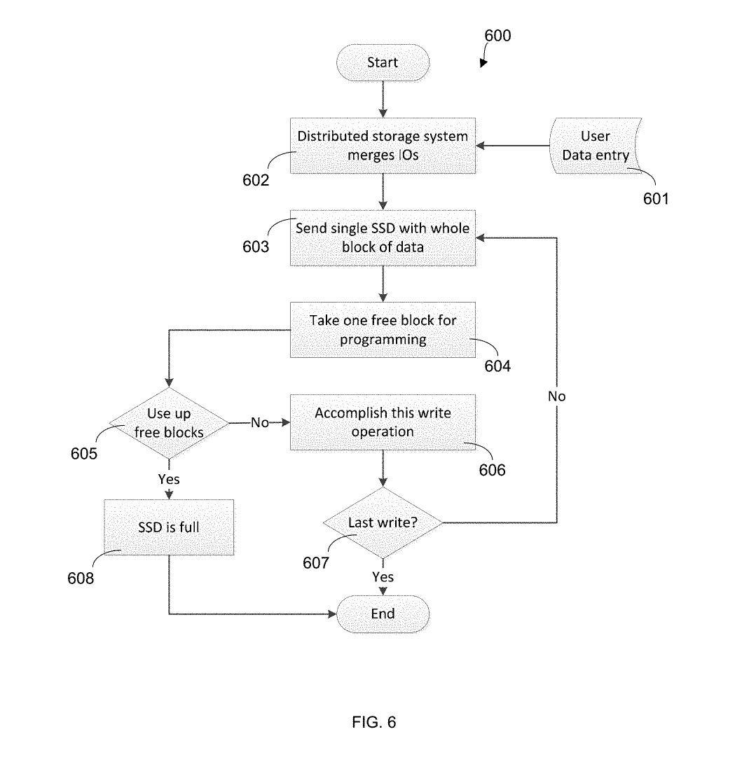

Portions of the detailed description that follows are presented and discussed in terms of a method. Although steps and sequencing thereof are disclosed in a figure herein describing the operations of this method, such steps and sequencing are exemplary. Embodiments are well suited to performing various other steps or variations of the steps recited in the flowchart (e.g., FIG. 6) of the figures herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### System and Method of Write Amplification Factor Mitigation and Flash Lifespan Extension

The following description is presented to enable a person skilled in the art to make and use the embodiments of this invention; it is presented in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Embodiments of the present invention use a NAND block as the basic write operation unit and ensure that the write operation uses the same basic unit as the erase operation. In this way, the flash product maintains the same level of granularity for read and write operations. The mapping between logical block addressing (LBA) and physical block addressing (PBA) are at the page level. Wear leveling and garbage collection are simplified so the robustness and performance is enhanced. If the data is frequently written, there are no concerns regarding data retention. When dealing with hot data, the NAND flash's required data retention capability may be adjusted to increase P/E cycles. By using a distributed storage system to merge small files and write data block-by-block, the write amplification factor approaches an ideal value of 1.

Flash devices such as SSDs experience increasing write amplification mainly due to small chunks of data updates or deletions. One primary reason for write amplification is the mismatch between the programming unit and the erasing unit. After some pages are updated or deleted, the original pages become invalid. However, all pages in the same block do not become invalid at the same time. Therefore, when an SSD runs out of free blocks, the blocks with the fewest valid pages are chosen for erasing.

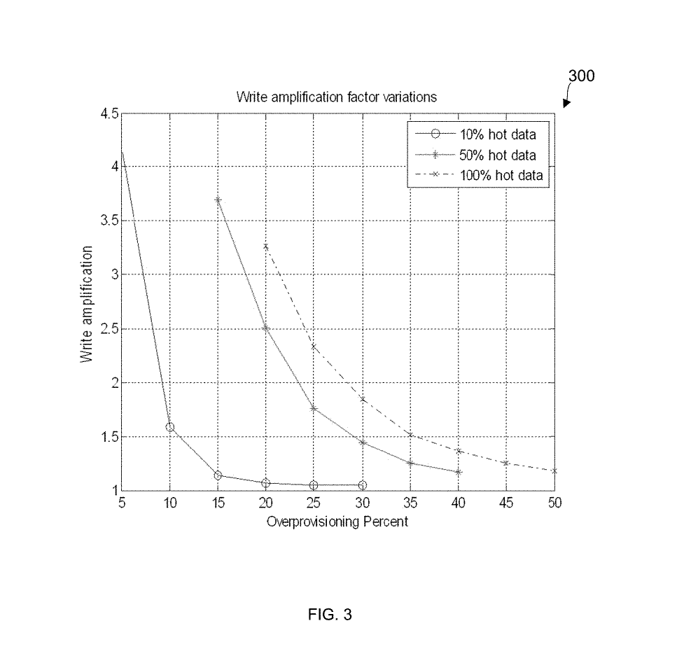

With regard to FIG. 3, graph 300 illustrates write amplification factors compared to an overprovisioning percentage for an exemplary SSD according to embodiments of the present invention. Each plot on the graph represents a data group having a different percentage of “hot” data. Hot data is data that is updated frequently. Data is that is rarely updated after initially being written is considered “cold” data. Plot 301 represents a data group comprising 10% hot data, plot 302 represents a data group comprising 50% hot data, and plot 303 represents a data group having 100% hot data. In general, graph 300 illustrates that reducing the amount of hot data in a data group effectively mitigates the write amplification factor. Embodiments of the present invention evenly distribute hot data using a global optimization perspective based on this observation.

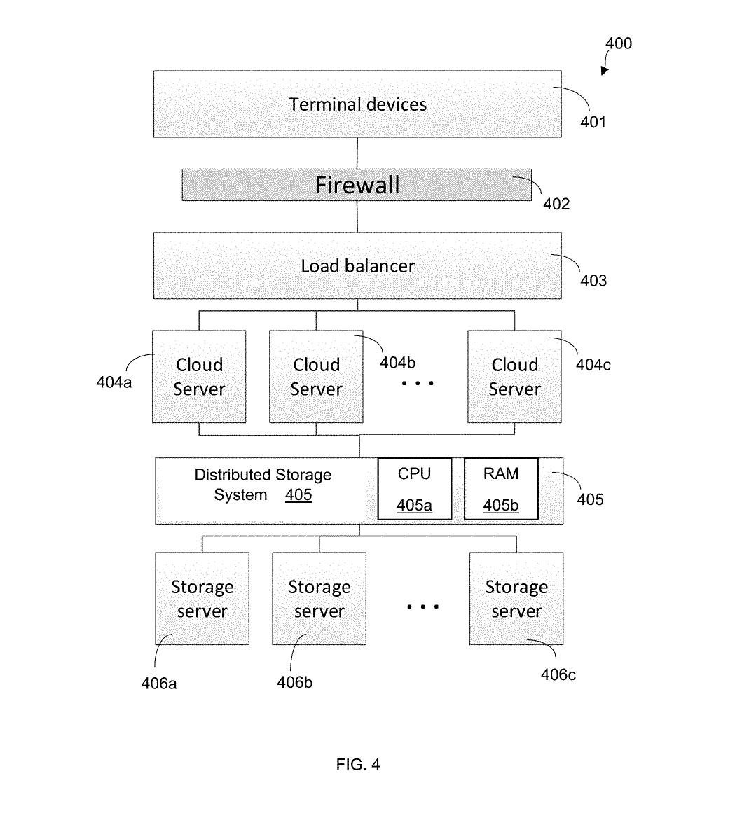

With regard to FIG. 4, an exemplary cloud service system 400 is depicted according to embodiments of the present invention. Cloud services system 400 may comprise one or more storage systems (e.g., distributed storage system 405) accessed by terminal device 401. Terminal device 401 may comprise a personal computer, tablet, smartphone, wearable device, or any other device operable to exchange data with a network or storage device. Load balancer 403 receives data requests and orchestrates traffic passing through Firewall 402 so that cloud servers 404a-404c receive user data and process the data accordingly. Data is stored using the distributed storage system 405 comprising multiple storage servers 406a-406c. The storage servers 406a-406c may comprise a single SSD, or a system having an array of SSDs, for example. Storage virtualization may be used so that a user may interact with the cloud services system in the same way as a traditional computer. Behind the virtualization layer, the actual resources are manipulated based on global optimization techniques, where the time difference, region variance, and physical server performance deviations are masked. Consequently, the cloud services system delivers a stable and efficient solution for exchanging large amounts of data.

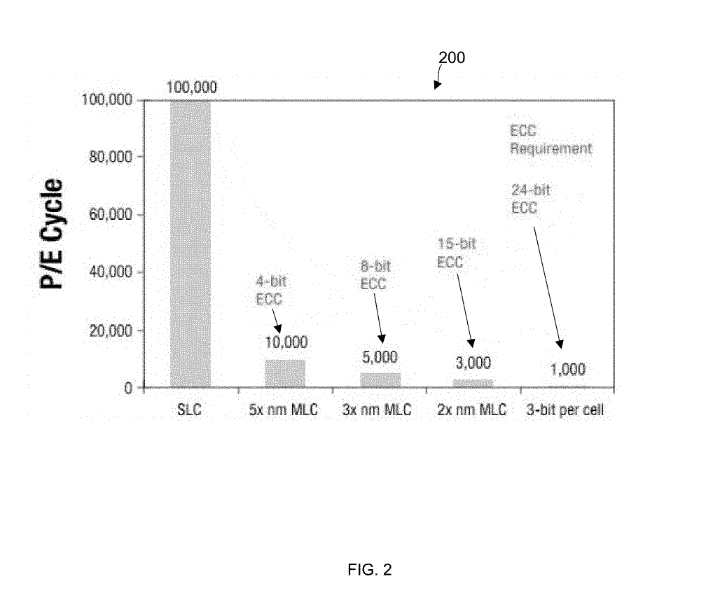

According to some embodiments of the present invention, a distributed storage system (e.g., distributed storage system 405) that acts as a file blender to merge incoming data and subsequently spread the data among multiple destinations is used to evenly distribute hot data among the SSDs. The distributed storage system may comprise one or more processors (e.g., CPU 405a) for analysing and directing data to the SSDs, and RAM 405b for storing data. Considering the results depicted in FIG. 2 regarding the relationship between hot data and write amplification, one exemplary solution comprises dividing the files with hot data into stripes and distributing the strips of hot data to several (e.g., ten or more) SSDs to avoid a high frequency of hot data access for any particular SSD. This solution utilizes global optimization techniques and makes each SSD's hot data percentage approach the average percentage of hot data. Therefore, local or temporary hot data will be handled efficiently. Because these file are stored in a multiple stripe format across multiple SSDs, the files may be accessed in parallel which leads to improved IOPS and throughput performance.

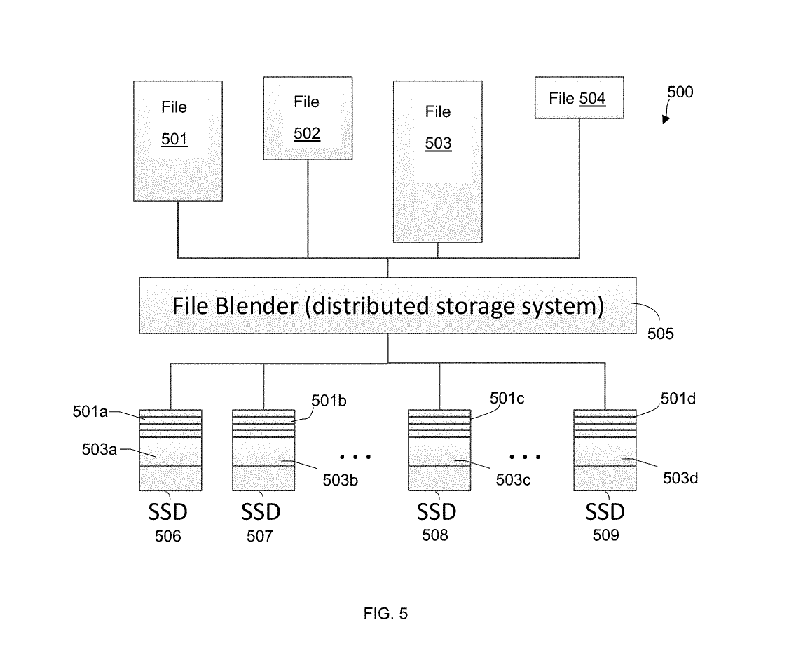

With regard to FIG. 5, an exemplary distributed storage system 500 configured as a file blender is depicted according to embodiments of the present invention. For example, File 501, File 502, File 503, and File 504 are four files with different sizes and hotness. If it is determined that File 502 is updated frequently, rather than writing B to one SSD, file B may be written to SSDs 506-509 as stripes. For example, stripe 502a may be written to SSD 506, stripe 502b to SSD 507, stripe 502c to SSD 508, and stripe 502d to SSD 509. There may be more stripes written to to more SSDs (not pictured). The stripe size or the data amount written from file B may vary between SSDs, and the stripe size can be adjusted based on individual SSDs capacity and performance. For one physical SSD, only a stripe of hot data from file B is written. Another file, File 503 is also distributed as stripes to SSDs 506-509. Stripe 503a is written to SSD 506, stripe 503b is written to SSD 507, stripe 503c is written to SSD 508, and stripe 503d is distributed to SSD 509. The stripe size may vary between different SSDs. Files 502 and 504 may also be distributed to the SSDs as stripes in a similar manner. This technique promotes balanced system wear and reduce the likelihood of single-point failure. Furthermore, reliability is enhanced and operation costs are reduced.

As mentioned above, the stripe size written to each SSD may vary. Besides global optimization based on the distribution of hot data, embodiments of the present invention use NAND flash block-wise operation to control write amplification. For example, distributed storage system 505 may be used as a data pool to buffer, blend, and merge data to be stored on SSDs 506-509. Therefore, utilizing this coherent middle layer, distributed storage system can merge small inputs/outputs (IOs) and increase the block size. As mentioned previously, one root cause of write amplification is the mismatch between the erase operation unit (e.g., block) and the program operation unit (e.g., page). When IOs are merged and written block-by-block, invalid/valid pages are no longer a concern. As a result, an entire block is written or erased at a time, and garbage collection is significantly simplified such that no valid page will be copied from the block to be erased and re-written elsewhere.

With regard to FIG. 6, an exemplary sequence of computer implemented steps 600 for performing block-wise programming and erasing for hot data in a multi-SSD storage system is depicted according to embodiments of the present invention. At step 601, a user data entry is received by a distributed storage system. At step 602, the distributed storage system merges IOs to form a block size of one NAND flash block. At step 603, a whole block of data is sent to a single SSD. At step 604, a flash controller takes one non-empty free block from the free block pool. The entire block is programmed sequentially page-by-page.

A deletion operation also uses an entire block as the basic unit. Consequently, the garbage collection becomes simpler because if one data block is deleted, the block will be returned to free block pool for future write operations. At step 605 it is determined if all free blocks have been used. If so, the SSD is determined to be full at step 608 and the process ends. If there are free blocks remaining at step 605, the process continues to step 606 where the data is written to a free block. At step 607 it is determined if there is additional data to be written. If so, the process returns to step 603 and continues. Otherwise, if it is determined that there is no further data to be written at step 607, the process ends.

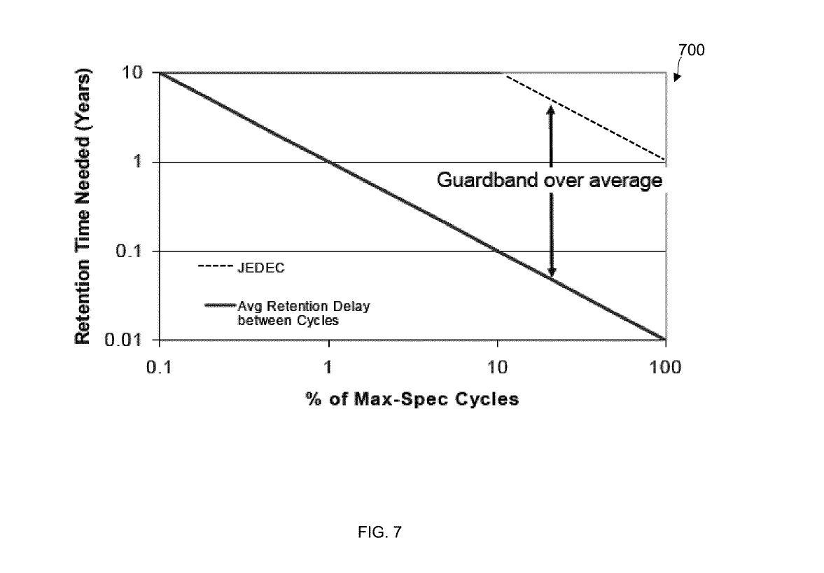

With regard to FIG. 7, an exemplary graph 700 illustrates retention time needed compared to a percentage of maximum cycles. Graph 700 indicates that by targeting different applications, the retention time can be adjusted to improve the total number of P/E cycles. Based on online data collected from data center, the characteristics of data is extracted to determine the maximum data retention required, then the NAND flash is adjusted accordingly using a new configuration, and the maximal P/E cycles of this NAND flash is increased. At the same time, when the lifespan is unchanged, the increased number of PIE cycles means the write amplification effect is mitigated.

Embodiments of the present invention are thus described. While the present invention has been described in particular embodiments, it should be appreciated that the present invention should not be construed as limited by such embodiments, but rather construed according to the following claims.

What is claimed is:

1. A method of distributing data among a plurality of solid state drives to mitigate write amplification, comprising:
receiving a write request comprising write data;
determining a portion of the write data comprising hot data;
dividing the hot data into a plurality of stripes; and
writing each of the plurality of stripes to a different solid state drive.

2. The method of claim 1, further comprising writing a remainder of the write data, if any, to a free block of one of the plurality of solid state drives.

3. The method of claim 1, wherein the plurality of stripes are operable to be accessed in parallel.

4. The method of claim 1, wherein a stripe size of each of the plurality of stripes is adjusted based on a capacity and/or a performance metric of the associated solid state drive.

5. The method of claim 1, wherein each of the plurality of stripes is merged with another set of stripes before writing and a size of the merged stripes equals a block size.

6. The method of claim 5, wherein the block size is 4 MB.

7. The method of claim 5, wherein the block size is 8 MB.

8. An apparatus for distributing data among a plurality of solid state drives to mitigate write amplification, comprising:
a load balancer configured to receive and direct data requests, wherein the data requests comprise write data;
a distributed storage system coupled to the load balancer configured to store data; and
a plurality of solid state drives coupled to the distributed storage system for storage,
wherein the distributed storage system receives data requests from the load balancer and separates any hot data into a plurality of stripes, wherein each of the plurality of stripes is merged with another set of stripes, wherein a size of the merged stripes equals a block size.

9. The apparatus of claim 8, wherein the block size is 4 MB.

10. The apparatus of claim 8, wherein the block size is 8 MB.

11. The apparatus of claim 8, wherein the distributed storage system divides hot data into a plurality of stripes and writes each of the plurality of stripes to a different solid state drives.

12. The apparatus of claim 11, wherein each of the plurality of stripes is merged with another set of stripes before writing and a size of the merged stripes equals one block.

13. The apparatus of claim 11, wherein a stripe size of each of the plurality of stripes is adjusted based on a capacity and/or a performance metric of the associated solid state drive.

14. A computer program product tangibly embodied in a computer-readable storage device and comprising instructions that when executed by a processor perform a method for distributing data among a plurality of solid state drives to mitigate write amplification, the method comprising:
receiving a write request comprising write data;
determining a portion of the write data comprising hot data;
dividing the hot data into a plurality of stripes; and
writing each of the plurality of stripes to a different solid state drive.

15. The method of claim 14, further comprising writing a remainder of the write data, if any, to a free block of one of the plurality of solid state drives.

16. The method of claim 14, wherein the plurality of stripes are operable to be accessed in parallel.

17. The method of claim 14, wherein a stripe size of each of the plurality of stripes is adjusted based on a capacity and/or a performance metric of the associated solid state drive.

18. The method of claim 14, wherein each of the plurality of stripes is merged with another set of stripes before writing and a size of the merged stripes equals a block size.

19. The method of claim 18, wherein the block size is 4 MB.

20. The method of claim 18, wherein the block size is 8 MB.
